(19) United States
(12) Patent Application Publication
(10) Pub. No.: US 2018/0004384 A1
(43) Pub. Date: Jan. 4, 2018

(54) ROOM CONSOLE FOR MANAGEMENT OF PATIENT CARE

(71) Applicant: Rauland-Borg Corporation, Mount Prospect, IL (US)

(72) Inventors: Patrick E. Fitzgerald, Arlington Heights, IL (US); Jennifer A. Holden, Mundelein, IL (US); Brian W. Kidder, Libertyville, IL (US)

(21) Appl. No.: 15/198,683

(22) Filed: Jun. 30, 2016

(51) Int. Cl. G06F 3/0488; A61G 12/00; G06F 3/0481; G06F 3/0482

(52) U.S. Cl. CPC G06F 3/0488; G06F 3/0482; A61G 12/00; G06F 3/04817

(57) ABSTRACT

A room console device for management of patient care includes a touchscreen, a processor, and instructions stored on a non-transitory computer-readable medium, such that when the processor executes the instructions, the room console device is able to complete a staff registration process and provide an indication of staff registered in a room where the room console device is located. Additionally, the room console device can provide outstanding calls to registered staff members and provide an indication of registered staff in other rooms where the room console device is not located. The room console device is further able to participate in an audio communication session and set a service.

### BACKGROUND

Hospitals are equipped with nurse call systems that utilize various devices located throughout the hospital. The nurse call systems enable patients and/or nurses to communicate over a network with one or more nurse stations. The nurse call system helps in organizing hospital resources and facilitating communication in the hospital environment so as to enhance patient safety and improve staff efficiency. Even with the nurse call system, there are still improvements that may be made in how healthcare providers' staff members coordinate with one another in order to enhance quality and care of a patient.

### SUMMARY

In an exemplary embodiment, a room console device for management of patient care is provided. The room console device includes a processor and instructions stored on a non-transitory computer-readable medium, such that when the processor executes the instructions, the room console device is able to complete a staff registration process and provide an indication of staff registered in a room where the room console device is located. Additionally, the room console device can provide outstanding calls to registered staff members and provide an indication of registered staff in other rooms where the room console device is not located. The room console device is further able to participate in an audio communication session and set a service.

In an exemplary embodiment, a method for management of patient care is provided. The method is performed on a room console device by executing instructions stored on a non-transitory computer-readable medium, and the method includes displaying, by the room console device, an icon driven registration graphical user interface (GUI) on a touchscreen of the room console device, wherein the registration GUI comprises staff level indicators on one or more staff level icons. The method further involves receiving, by the room console device, a staff registration signal from the touchscreen, wherein the staff registration signal associated a staff level indicator. In response to the staff registration signal, the method involves displaying, by the room console device, the staff level indicator on the touchscreen.

In an exemplary embodiment, a method for management of patient care is provided. The method is performed on a room console device by executing instructions stored on a non-transitory computer-readable medium, and the method includes displaying, by the room console device, an icon driven GUI on a touchscreen of the room console device, wherein the GUI comprises staff level indicators representing at least one registered staff member. The method then involves receiving, at the touchscreen, a first input signal indicative of an audio communication session, and in response to the received first input signal, displaying, on the touchscreen, icons corresponding to different audio communication options. Then the method further includes receiving, at the touchscreen, a second input signal indicative of a selected audio communication option, and initiating and maintaining the selected audio communication option.

### BRIEF DESCRIPTION OF THE SEVERAL VIEWS OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 provides an example environment 100 for a healthcare provider's nurse call system;

FIG. 2A provides an example of a room console device;

FIG. 2B provides a sample block diagram identifying several components in the room console;

FIG. 3 provides a software flow diagram showing information flow between different software modules of the room console;

FIG. 4A illustrates an exemplary screenshot of the touchscreen on the room console when no staff is registered;

FIG. 4B illustrates an exemplary screenshot of the touchscreen on the room console when staff is registered;

FIG. 5A illustrates an exemplary screenshot of the touchscreen on the room console when a registered staff is at a home screen;

FIG. 5B illustrates an exemplary screenshot of the touchscreen on the room console when an audio session is active;

FIG. 6A shows examples of symbols that may be displayed on the home screen of the room console;

FIGS. 6B-C show exemplary implementations of a status bar on the home screen;

FIGS. 7A-C show exemplary screenshots of the touchscreen on the room console when setting a service;

FIGS. 8A-D show exemplary screenshots of the touchscreen on the room console when in audio mode;

FIGS. 9A-B show exemplary screenshots of the touchscreen on the room console when multitasking; and

FIG. 10 shows an exemplary screenshot of the touchscreen on the room console when locating staff.

### DETAILED DESCRIPTION

Healthcare providers that manage multiple patients with a limited number of staff members utilize nurse call systems to facilitate communication between the staff and patients. The nurse call system not only serves to enhance communication between staff and patients, but it also improves communication among staff members. For example, a nurse attending to a patient in a hospital room may register his or her location using a device that interfaces with the nurse call system. In so doing, other staff members of the hospital know the location of the nurse when they view visual indicators such as corridor lights. Several devices may interface with nurse call systems, for example, a pillow speaker, a pullcord, corridor lights, staff terminals, etc. The capabilities and functionalities of these devices range from performing complex tasks like making phone calls to simple tasks like turning on an alarm. As device offerings for nurse call systems continue to grow, a main constraint in introducing new devices has to do with financial cost per device. When a healthcare provider invests in a device to interface with its nurse call system, the healthcare provider will most likely have to spend on hundreds if not thousands of units for this device. As such, the cost of each device compared with its capabilities is important, especially to a large hospital.

Embodiments of the disclosure are able to quickly provide information regarding staff member registration. For example, a staff member enters a patient's hospital room and completes the registration process by pressing a button next to a doorway. In so doing, the corridor light lights up to indicate the level of the staff registered in the given room using a color code, for example, a steady yellow lamp for cleaning staff, and an amber color for a nurse's aide. In a conventional system, other staff members may be able to see the corridor lights when they are out in the hallway, but when they are in a hospital room, they would have to leave the room to the corridor in order to view the light. For example, if a nurse is attending to a patient and needs to find the closest doctor, he or she would have to walk out to the corridor to get a glimpse of the corridor lights for each room in the hallway. In so doing, a patient who may need immediate attention would be left alone unattended. Using embodiments of the disclosure, however, the nurse would have the information he or she needs in the patient's room (as well as various other capabilities related thereto) and would not need to leave the room.

Some embodiments of the disclosure provide a room console device with the ability to identify and locate staff members throughout a coverage area in, for example, a clinic, a hospital, etc. A staff member that has registered in a room can use the room console to quickly scroll through the list of other registered staff to: (1) know who is physically located in their coverage area; (2) travel to the specified location to meet directly with the identified staff member; (3) use the room console to establish an audio connection to the room with the desired staff member. These identified features are useful for either requesting assistance from any other registered staff member or identifying a specific staff member level (i.e., doctor) for assistance with specific tasks, such as administering certain medication.

Embodiments of the disclosure further provide a room console device with color-coded staff indicators for a quicker, more efficient way to locate registered staff. With this device, a staff member does not need to look up and down a corridor or other out-of-the-way areas, or to travel back to a nurse station to query a single room console. The room console provides the registered staff information to every room simultaneously so that all staff members have the ability to query the location of all other registered staff members.

Yet some embodiments of the disclosure provide a room console device where a displayed call on the room console device shows a required-staff level. The indicator of the required-staff level would improve staff efficiency, so that staff would only respond to calls that were specifically identified for their level. For example, an aide would not respond to a call where a nurse was required, thus allowing the aide to avoid an unnecessary trip to a room where they could not provide the requested assistance. In some scenarios, since all staff members can view all outstanding calls, a higher level staff member could respond to a lower level staff call if desired, whereas in other scenarios, the higher level staff member may not even be aware of the outstanding call since the call notification would initially not be routed to that higher level staff member unless the outstanding call was escalated. Overall staff efficiency will be improved (a nurse could answer a call designated for an aide if the aide were busy with another call, but before the call is escalated). As such, the patient would receive care sooner due to an adoption of some embodiments of the disclosure.

Embodiments of the disclosure provide a room console that may be provided in each room of a healthcare provider's facility. The room console is a device that allows hospital staff to register (i.e., check in) to a room when attending to a patient. The room console also allows staff members or patients to page other staff members and/or communicate with staff members in other rooms. The room console further provides the ability to log cleaning and janitorial staff activities in a room, patient transport, etc. Embodiments of the disclosure will provide exemplary implementations of additional features of the room console as well.

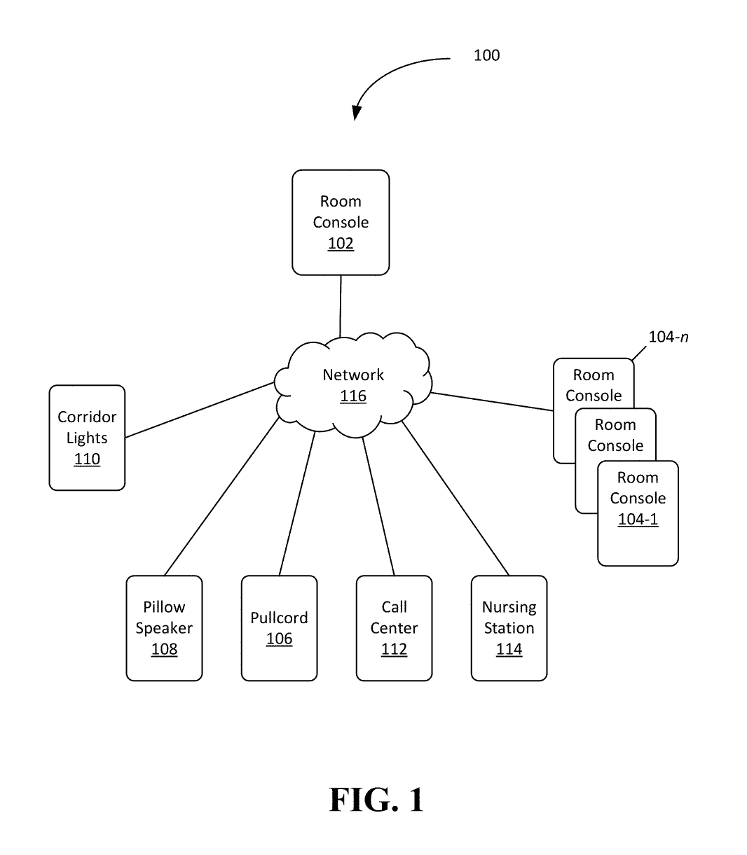

Before detailing the features of the room console, an exemplary environment 100 of a nurse call system is provided in FIG. 1. The environment 100 in FIG. 1 includes a room console 102 in communication with one or more other room consoles 104-1 to 104-n, pullcord 106, a pillow speaker 108, corridor lights 110, call center 112, and nursing station 114. In certain embodiments, a room console is used in every patient room, e.g., every patient room in a hospital has a room console. The room consoles 104-1 to 104-n in FIG. 1 each exist in different rooms and have similar functionality to room console 102.

The environment 100 may have a pullcord 106 in the vicinity of a patient's room. For example, the pullcord 106 may be located in a private bathroom for the patient, and the patient may be able to pull on it to alert staff members of an emergency. Pullcord 106 may be placed in other locations within a patient's room as well, especially when dealing with patients with high risk of falling. Additionally, pillow speaker 108 may be provided close to a patient's bed for television remote control, emergency call function, and simple communication with a caregiver's staff. The pullcord 106 and the pillow speaker 108 are provided as examples of devices a patient has access to that interface with a nurse call system. These devices may be generalized to other devices, for example, a call button located next to a patient's bed, etc.

The environment 100 may include corridor lights 110 which are used as indicator lights to alert staff members and a patient's family members when a staff member is in the patient's room. The room console 102 may have access through network 116 to the corridor lights 110. In some embodiments, when a staff member is registered as being in the patient's room, the corridor light 110 lights up. In some instances, the corridor light 110 comprises multiple colored lights, and a certain light color is lit depending on the level of staff member that is registered in the patient's room. For example, when a doctor is in the room, a corresponding corridor light 110 lights up as blue, and when a nurse is in the room, the corresponding corridor light 110 lights up as green. When staff members of multiple levels are in the room, multiple lights are lit up according to the light colors corresponding to the staff members. When a staff member registers with room console 102, the room console 102 may, through network 116, instruct the corridor lights 110 to turn on. Corridor lights 110 are provided as an example of a visual indicator, but other indicators may interface with the room console 102. These may include visual displays outside the patient's room, like monitor screens, seven segment displays, etc.

The environment 100 may include call center 112. In some instances, call center 112 provides call management for all calls, so when a call is placed on room console 102, the room console 102 provides the call to the call center 112. Call center 112 then displays information regarding the call. Information may include, for example, room number, call priority, the level of staff necessary, etc. The environment 100 also provides a nursing station 114 which is responsible for synchronizing staff assignments across multiple systems throughout the hospital. The call center 112 and nursing station 114 are provided as examples to illustrate that room console 102 may interface with higher level systems managed by the hospital or healthcare provider.

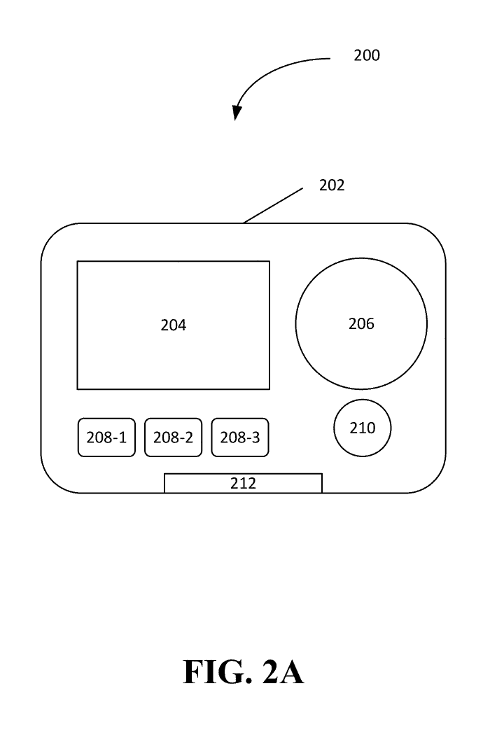

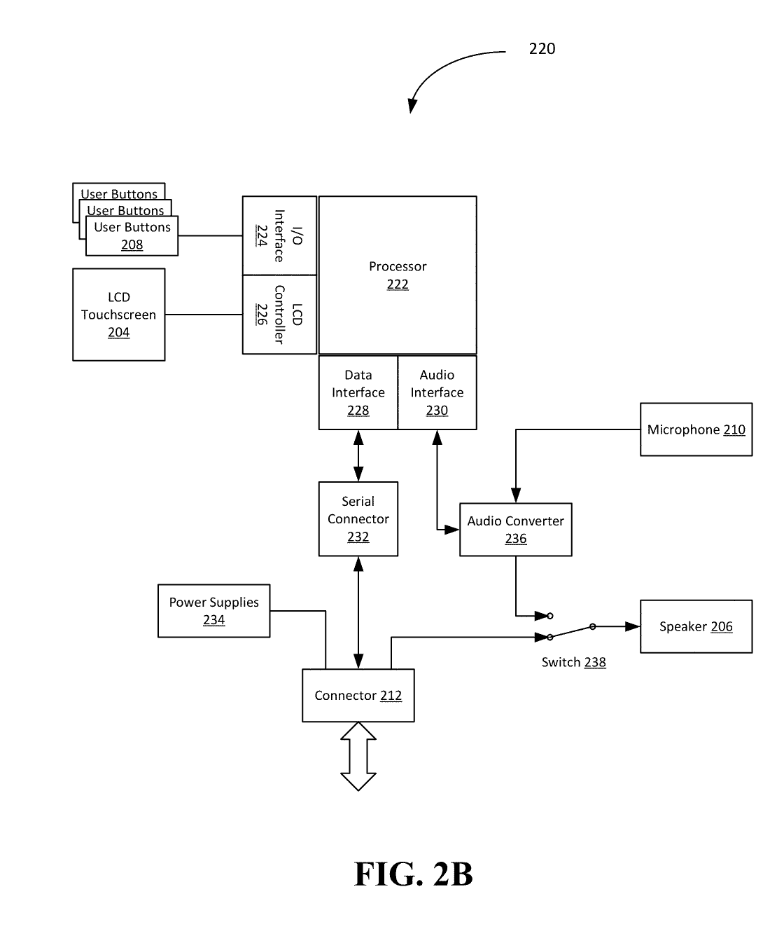

FIG. 2A illustrates an exemplary embodiment of a room console device. The room console device has a body 202, an interactive display or a liquid crystal display (LCD) touchscreen 204, and a connector 212. The touchscreen 204 may support multiple touch functionality, drag and drop functionality, color, and gestures. The room console may include physical buttons (e.g., buttons 208-1 to 208-3), an audio output device or a speaker 206, an audio input device or a microphone 210. The connector 212 may be provided on the rear of the device. The physical buttons may include, for example, a call button 208-1, a cancel call button 208-2, and a push to talk button 208-3.

FIG. 2B illustrates an example of a block diagram 220 identifying several components in the room console of FIG. 2A. The room console includes a processor 222. The processor 222 may be an energy efficient processor like the ARM® Cortex®-M4 processor. The processor 222 includes at least one internal memory (not shown) to run programs corresponding to the functionalities ascribed to the room console. The LCD touchscreen 204 interfaces with the processor 222 through an LCD controller 226. The user buttons 208 interface with processor 222 through an input/output (I/O) interface 224. I/O interface 224 may include general purpose input output (GPIO) pins that allow processor 222 to respond to user buttons 208. Audio paths from the microphone 210 and audio paths to the speaker 206 may interface with processor 222 through an audio interface 230. In some embodiments, audio interface 230 is an integrated interchip sound (I²S) interface. Sharing the audio interface 230 may be accomplished through an audio converter 236. Examples of audio converter 236 include Texas Instruments TCV320AIC3104. Audio converter 236 provides bidirectional communication with audio interface 230. In some instances, this bidirectional communication is accomplished in the digital domain, i.e., audio signals sent and received on this line are digital signals. Audio converter 236 receives audio signals from microphone 210, and in some instances audio converter 236 receives analog audio signals from microphone 210. Audio converter 236 provides audio signals to speaker 206 through switch 238, and in some instances audio converter 236 provides analog audio signals to speaker 206.

Processor 222 may receive and process data originating from other devices besides those already mentioned. In the exemplary embodiment of FIG. 2B, connector 212 is provided as the interface to the outside world. The data communication mode identified in FIG. 2B is serial communication, so a serial connector 232 is provided between connector 212 and data interface 228. Connector 212 may be an 8-pin connector, serial connector 232 may be an RS-485 connector, and data interface 228 may be a universal asynchronous receiver/transmitter (UART). The interface to receive and send data provided in FIG. 2B is only an example. Other configurations that support a parallel data readin/readout may be utilized. In some instances, the connector 212 may not be the only conduit for data transfer, and a wireless receiver/transmitter may be included as another path to obtaining and sending data. Connector 212 also has one or more pins dedicated to power supplies for the various components in the room console. Switch 238 is directly connected to connector 212 since not all audio received by the room console needs to be processed by processor 222. For example, when in audio communication with another room console, the audio data may be relayed directly to speaker 206.

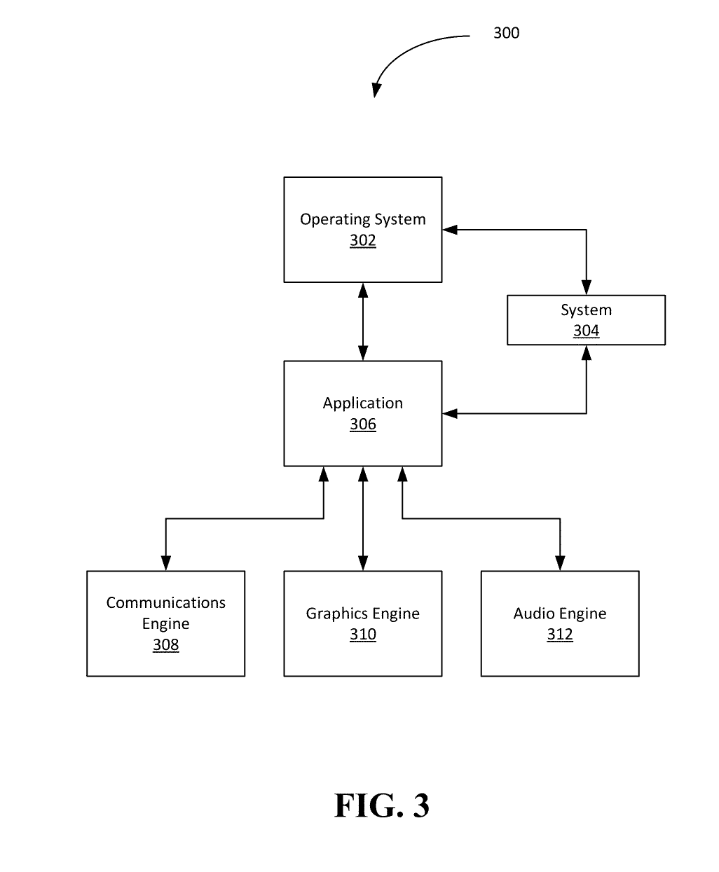

FIG. 3 illustrates a software flow diagram 300 showing information flow between different software modules of the room console. The room console runs an operating system 302 on processor 222. The operating system 302 manages hardware and software resources on the room console. System 304, identified separately from the operating system 302, is responsible for firmware updates and serves as a watchdog. Application 306 is the software that provides the different functionality necessary for several embodiments of the room console provided in this disclosure. Application 306 also serves to manage other software modules or drivers. For example, application 306 determines when to activate audio engine 312 to receive, send, and process audio data. In the embodiment of FIG. 2B, the audio engine 312 runs on processor 222 and takes advantage of the audio pathway with audio components such as the connector 212, microphone 210, and speaker 206. Application 306 also determines when to process and display graphics data through graphics engine 310. Graphics engine 310 is software engine related to the touchscreen 204. Touch inputs to touchscreen 204 may cause the application 306 to trigger a visual output on touchscreen 204, hence the bidirectional information flow. For example, a user presses a button on the touchscreen 204 and the button changes color. Communications engine 308 is a software engine related to data manipulation, reception, and transmission. Communications engine 308 takes advantage of the data pathway provided in FIG. 2B. For example, when a firmware update is necessary, communications engine 308 is activated by application 306 to receive the new firmware. In another example, the room console may interface with a call center 112 to receive the most recent outstanding calls. Communications engine 308 would be responsible for receiving the data related to the calls, and application 306 may organize the data in a format to display on touchscreen 204 using graphics engine 310.

Discussion so far has provided an exemplary environment for a room console, a sample depiction of a room console, and hardware and software components that enable certain attributes of the room console. The remainder of the disclosure will provide exemplary user interface interactions with a room console in accordance with some embodiments of the disclosure.

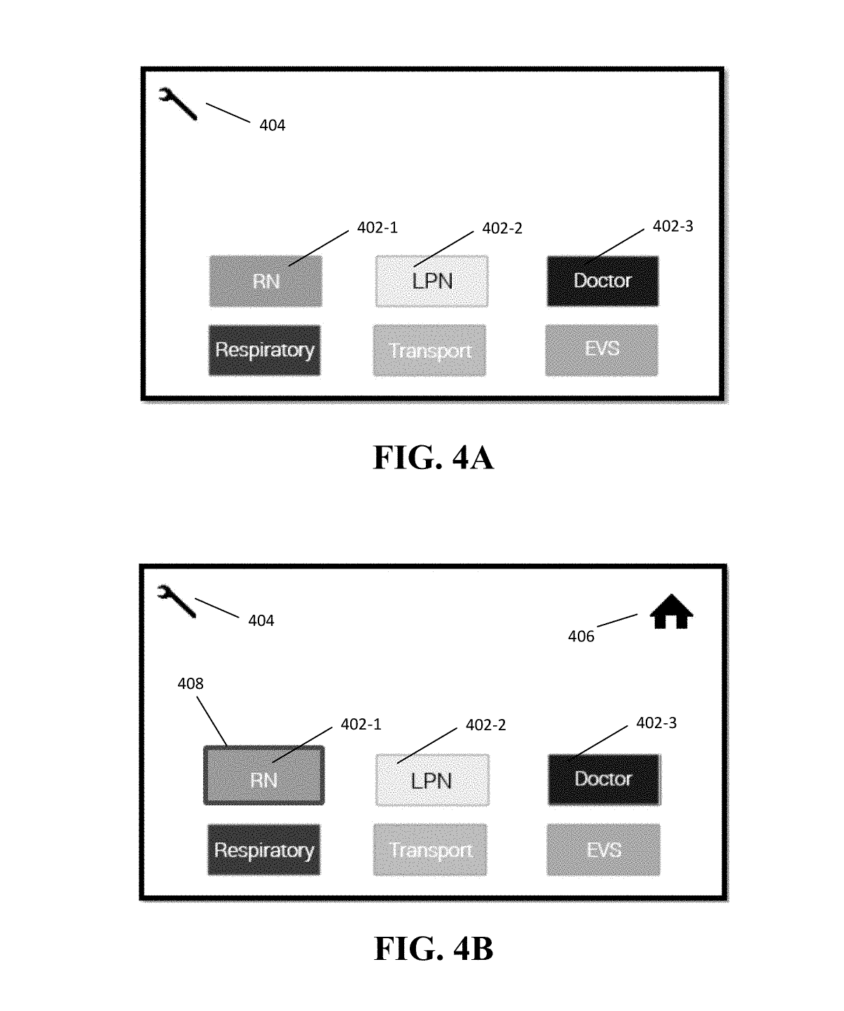

Embodiments of the disclosure provide a room console device with an icon driven graphical user interface (GUI). FIGS. 4A and 4B show sample screenshots of a touchscreen of the room console device when a staff is not registered and when a staff is registered, respectively. For simplicity in description, the screen depicted in FIGS. 4A-B is named the Staff Registration screen. In some embodiments, at the Staff Registration screen, when a staff member is not registered (FIG. 4A), staff member icons 402 and a settings icon 404 are displayed on the screen. The staff member icons may be separated as registered nurse (RN) 402-1, licensed practical nurse (LPN) 402-2, and doctor 402-3. The different icons may have different color associations, for example RN 402-1 may be green, LPN 402-2 may be yellow, and doctor 402-3 may be blue. In some embodiments, instead of or in addition to different color associations, the different icons may have different symbols following their labels. In some embodiments, other staff levels besides 402-1 to 402-3 may be selected. For example, in FIG. 4A, Respiratory, Transport, and EVS icons are depicted. Respiratory level staff are staff that administer respiratory therapy, for example, oxygen therapy, etc. Transport level staff are staff that are involved in transporting a patient from one place to another. EVS level staff are staff responsible for environmental services of the patient, for example, cleaning and janitorial staff. The number of icons provided in the icon driven GUI may be programmed to the needs of the healthcare provider, providing more or less than 6 icons. Additionally, the colors or symbols associated with each staff level may also signify service levels and can be configured by the healthcare provider.

FIG. 4B shows a screenshot of the touchscreen when a staff is registered. In FIG. 4B, an RN is registered, thus the RN icon is highlighted with a thick border 408. After a staff member registers, the home icon 406 is enabled and visible on the screen. In some embodiments, instead of appearing when a staff registers, the home icon 406 may be grayed out or faded in FIG. 4A but not faded in FIG. 4B. In other embodiments, after the staff member registers, the room console device immediately displays the home screen without the need for the staff member to select the home icon 406. In some instances, the room console device immediate displays the home screen without waiting for another staff member to register. The provided embodiments ensure that a user must register before being able to access advanced features of the room console. Returning to the staff registration screen in FIG. 4B, another staff member may register by pressing a level other than the RN 402-1. For example, after an RN had registered in the room, a neurologist may enter the room and press the Doctor 402-3 icon to register. When this happens, a thick border would appear on the Doctor 402-3 icon. The thick border is used as an example, but other forms of visually marking an icon as selected may be used, for example, overlaying a pattern on a selected icon, placing a symbol on the selected icon, showing the selected icon as pressed or depressed, etc.

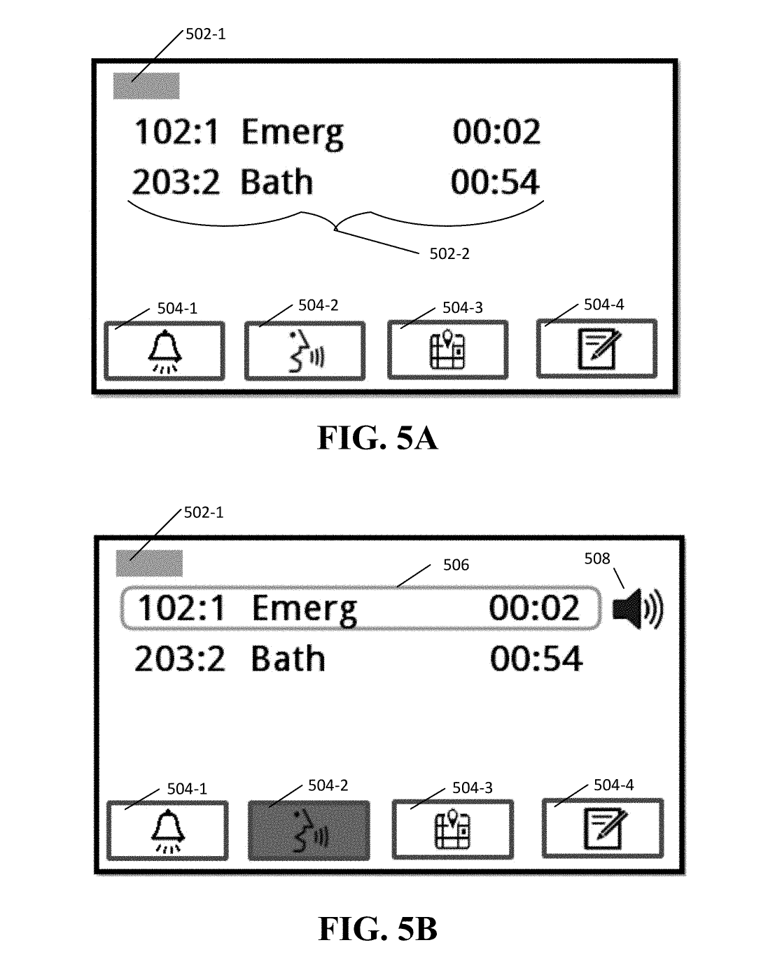

Embodiments of the disclosure provide a home screen with call status information, information regarding registered staff, and function icons. FIGS. 5A-B provide exemplary screenshots of a home screen. In FIG. 5A, when a staff member is registered, the home screen display provides call status information, level of registered staff members, and function icons that provide access to advanced features of the room console. In certain instances, the call status information is provided as a list as shown in item 502-2. In the provided example, call status information 502-2 shows that there is an emergency in room 102 involving the patient at bed 1. In addition, call status information 502-2 shows that the emergency in room 102 involving the patient at bed 1 has been unattended for a duration of 2 minutes. The elapsed time since the Emerg call was active may be provided in any desired format; the “hours:minutes” format is used as an example. Above the call status information 502-2, is an indicator of the level of registered staff member 502-1. In the provided example, an RN is currently registered in the room since the color of the indicator 502-1 is green, corresponding to the color of the RN icon 402-1 in the Staff Registration screen as provided in FIGS. 4A-B. The function icons 504-1 to 504-4 are provided at the bottom of the home screen. In the example, the four functions designate service 504-1, audio 504-2, staff locate 504-3, and registration 504-4. Four function icons are provided as an example, but the room console may be designed in a manner whereby the number of function icons may be more or less than four. Additionally, since the four function icons are soft buttons, their functionality may be changed in different situations, for example, depending on the level(s) of staff member(s) that have registered in the room.

FIG. 5B provides an example of the home screen when an audio session or an audio call is in progress. When an audio call is in progress, a speaker icon 508 is displayed next to the call related to the audio call. Additionally, a border selector 506 may encircle the call identifying it as related to the current audio session. Also, the audio icon 504-2 is modified from its previous representation to visually indicate that an audio call is active.

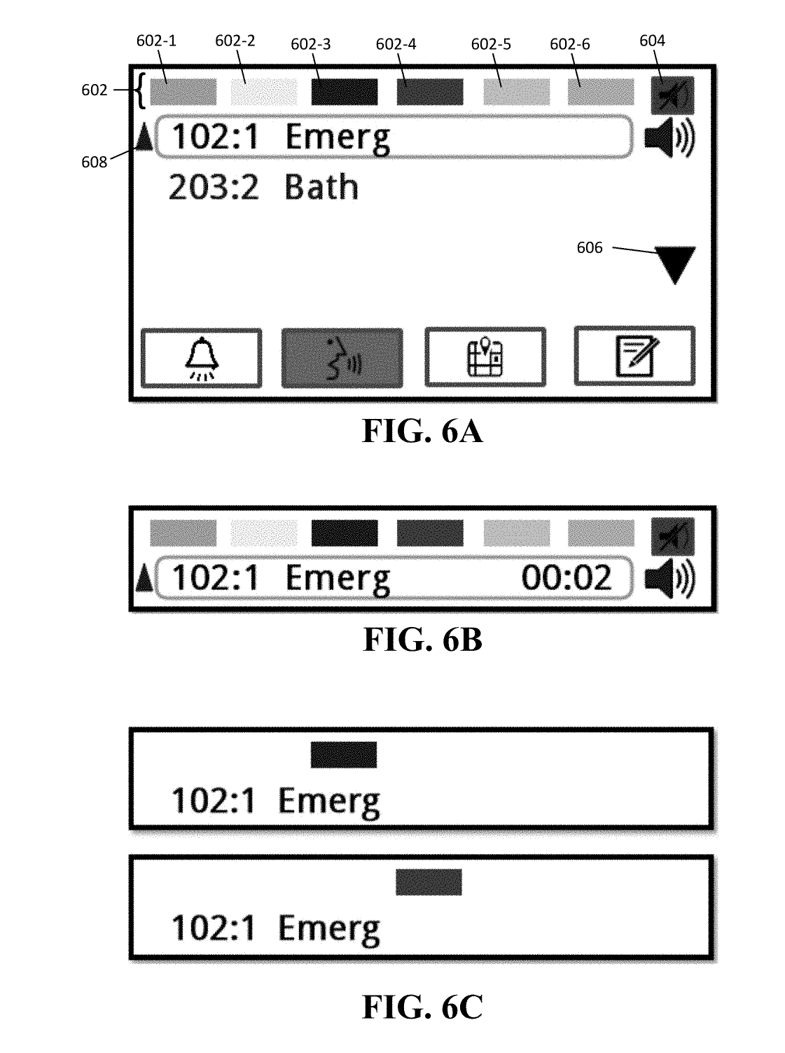

FIG. 6A shows an example of various items that may be incorporated in the home screen. When staff members are registered, the registered staff indicator bars 602 on the home screen display the level of the staff in the room. As an example, 6 staff levels are provided where each staff indicator bar may light up for the registered staff. Each of the 6 staff levels indicated by 602-1 to 602-6 correspond to the staff levels previously discussed in relation to FIG. 4A. Additionally, the home screen may have a mute symbol 604 representing muted tones from the room console device. In some cases, when there are too many calls to display, a scroll down icon 606 may be displayed on the home screen. A scroll up icon may also be used to scroll up (e.g., after a user has scrolled down using the scroll down icon 606). In some instances, a registered staff level icon 608 is indicated on the home screen next to each call. The registered staff level icon 608 indicates that a staff member is currently registered in the room identified in the call. The registered staff level icon 608 may be shown in different colors signifying the level of the registered staff member (or the highest level of a registered staff member in the room if multiple registered staff members are in the room), and thus the icon 608 in combination with the call information conveys the location of the staff member as well as the level of the staff member.

FIG. 6B illustrates an exemplary status bar with color indicators in addition to call information, and FIG. 6C illustrates two examples of a status bar with two different staff levels registered at different times in addition to call information.

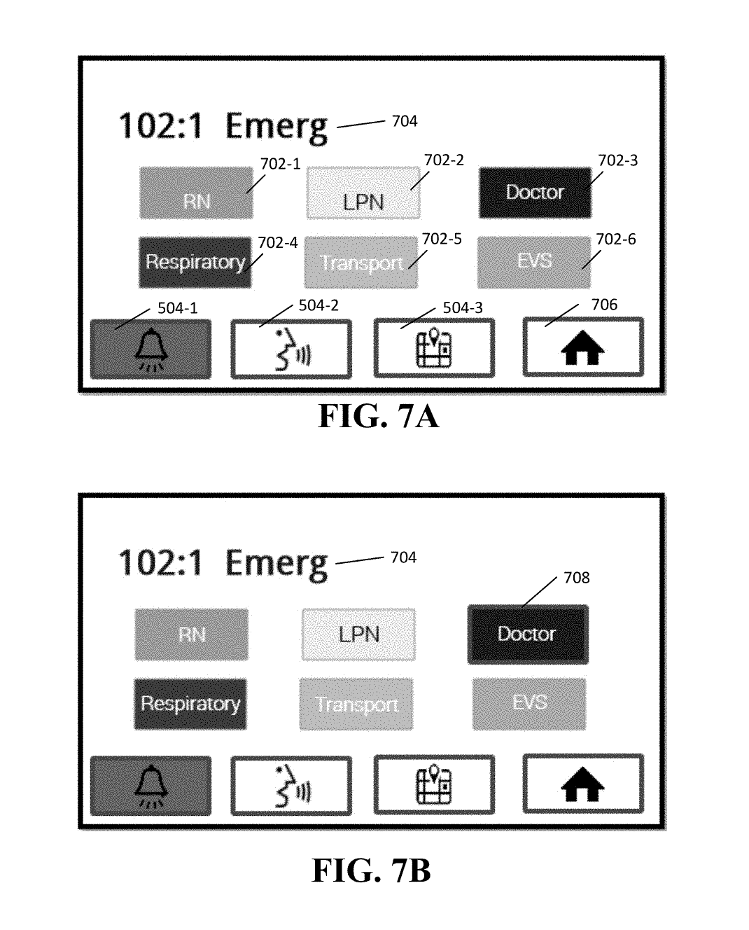

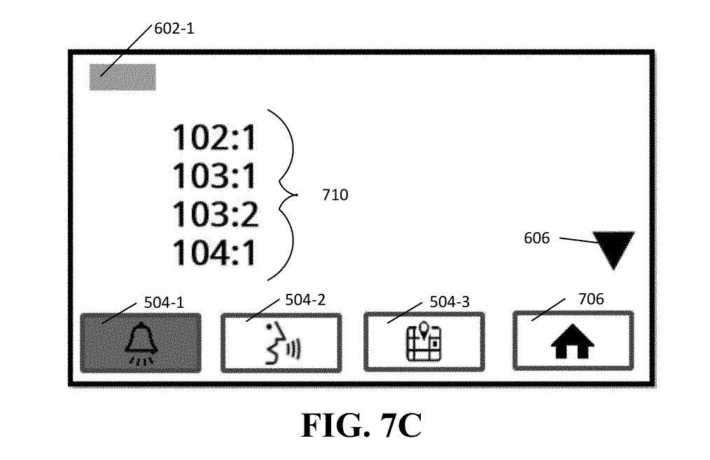

Embodiments of the disclosure provide a room console that allows a staff member to set a service. In some cases, there are multiple modes for setting a service. For example, a staff member can set a service to any displayed call, and FIGS. 7A-B show example screenshots that may be shown on the touchscreen when setting a service to a displayed call. When setting a service, the staff selects the displayed call 704 and then selects the service icon 504-1. The staff may then select the staff member level 702 needed to respond to the call from the available options corresponding to buttons 702-1 to 702-6. FIG. 7A shows a screenshot of the service-setting screen (i.e., while the service icon 504-1 is selected). FIG. 7B shows an example where the displayed call “Emerg” at room 102 bed 1 is assigned to a staff level of doctor as indicated by the displayed call 704 changing color to a color indicating a doctor should handle the call (e.g., by changing the text for the displayed call 704 to a blue color), as well as the thick border 708 surrounding the button 702-3 corresponding to “Doctor.”

In some embodiments, setting a service is a two-step process where the staff member selects a service type (changing the color of the call line text) in a first step, but the service is not actually set until the staff member exits the screen in a second step. This embodiment allows a user who has accidentally pressed the service icon to return to the home screen without setting a service. This embodiment also allows the user to hit a service type accidentally and then change it to another service type before exiting. In some cases, pressing the service icon 504-1 or the home icon 706 exits the service screen. In some cases, when a staff member hits a service type by accident, they can toggle off that service by pressing the same service type again before exiting. In various cases, a staff member can set a service to a call while in intercom communication corresponding to the call, or a staff member can set a service to a call without answering the call, or a staff member can set a service to a room:bed that does not currently have an active call.

In FIG. 7B an example showing that a displayed call “Emerg” at room 102 bed 1 is assigned to a staff level of doctor is provided. By displaying “Emerg” in the color blue, the blue color is used to indicate that “Emerg” should be attended to by a doctor-level staff. The example illustrates that the room console device may assign a call to a staff level and provide a visual indication that the call has been assigned to the specific staff level. In some embodiments, this staff level is the minimum level of required-staff that can respond to the call. In some instances, to achieve this feature, Application 306 in the room console device tracks each call in a nurse call data object. Associated with each nurse call data object is a required-staff variable that may store, for example, up to three levels of required-staff. Up to three levels are chosen here as an example because multiple staff levels may be simultaneously displayed on a corridor light when the room console device interfaces with a corridor light device. In the required-staff variable, all three staff-levels can be pending for a nurse call data object at one time. However, for the purpose of displaying the color of a call on the room console, Application 306 may choose either the highest-level of the three or the lowest-level of the three. In the case in which no specific staff level is required, a default call display color is used.

The required-staff variable may be stored as a complex or simple data object, for example, an array, a numeric code, etc. A numeric code may be devised, such that, “0001” denotes RN-level, “0011” denotes LPN and RN levels, “0111” denotes Doctor, LPN, and RN levels, etc., and “0000” denotes default where any available staff may respond. In some cases, instead of having to store a default code, using up limited storage in the room console device, the required-staff variable would hold no value or a null value when any available staff may respond. When stored as an array, the required-staff variable may store, for example, up three levels per nurse-call data object in a sorted-order. This means that, in this example, the length of the array may be limited to at most three objects. The array is null-terminated in case fewer than three levels of required staff are currently stored (i.e., fewer than three objects exist in the array). In some embodiments, if there are already three other levels stored and a new staff level is being added, then the lowest-rated of the four levels involved is discarded and the highest three are remembered. In other embodiments, the highest-rated of the four levels involved is discarded and the lowest three are remembered. When the required-staff variable array only contains the null-termination value, this indicates that no specific staff level is required to respond to the call, therefore the call is displayed in a default call display color.

The process of discarding the lowest-rated or highest-rated level may be accomplished in an array by first adding the new staff level to the array and then removing the lowest-rated or highest-rated level in the new array. The process of discarding the lowest-rated or highest-rated level may be accomplished in when the required-staff variable stores a numeric code by first comparing the three staff levels indicated in the numeric code and the new staff level. Then the required-staff variable is replaced with a numeric code indicating the highest three staff levels or a numeric code indicating the lowest three staff levels of the four staff levels. A maximum of three levels are used here as an example, but this approach may be used in cases where the maximum number of staff levels that may be stored (or represented) exceeds three.

Application 306 is responsible for maintaining and setting the required-staff variable. In one embodiment, Application 306 may automatically set and modify the required-staff variable through a known escalation chain. For example, a stored sequence of steps that are time-separated (the call's escalation chain) sets the required-staff variable at predetermined steps, so multiple steps that set different required-staff can exist in this escalation chain. For example, a call displayed on the room console device has a nurse call data object associated with a required-staff variable that indicates an RN-level staff should respond to the call. But if the call is not attended to within a specified time window, Application 306 automatically elevates the call by adding an LPN-level staff to the required-staff variable.

In another example, a call may require a staff of more than one level in a prescribed order, for instance, an RN-level staff may be needed for preparation and then a Doctor-level staff needed to complete the call. In this instance, Application 306 will first have the required-staff variable set for an RN-level staff, and after an RN-level staff registers in the room, Application 306 automatically escalates the call to a Doctor-level staff. In some embodiments, the escalation is performed after the RN-level staff unregisters. In some instances, Application 306 keeps track of the time elapsed since the RN-level staff registered and after a certain threshold is reached, escalates the call to a Doctor-level staff. The threshold may be set to, for example, an expected time the RN-level staff should complete a percentage of the preparation.

In addition to automatically setting a required-staff variable, Application 306 may use Communications Engine 308 and Graphics Engine 310 to manually set the required-staff variable based on user action. For example, Graphics Engine 310 may receive touchscreen inputs from a staff that selects a staff level displayed on the touchscreen 204 when setting a call to a specific staff-level. Application 306 may receive these touchscreen inputs from Graphics Engine 310 and set the required-staff variable associated with the call.

Another way to set the required-staff variable is to send a required-staff variable remotely from another device communicably coupled to the room console device through the Communications Engine 308. For example, a calling center or a nursing station may send required-staff information to the room console device. In some embodiments, a branch regional controller (BRC) may generate the required-staff information and send the required staff information to the room console device. The BRC would function as a centralized manager, pushing call data to multiple room console devices, where the call data includes nurse call data objects associated with required-staff variables. Application 306 would be responsible for receiving the call data from the Communications Engine 308 and displaying the call data with Graphics Engine 310. Application 306 would also be responsible for sending button or touchscreen commands to the BRC through the Communications Engine 308. An advantage of this setup is offloading heavy processing to the BRC, allowing a less complicated hardware design for the room console device. The BRC may be a computing device with one or more processors, memory, storage elements, and network interfaces communicably coupled to each other.

By having the BRC as a centralized manager, the BRC would be responsible for setting and maintaining required-staff variables. For example, in implementing an escalation chain, the BRC is tasked to use a stored sequence of steps that are time-separated to set the required-staff variable at predetermined steps. In an exemplary implementation, the BRC pushes call data to the room console device at 10 AM indicating that an RN-level staff should respond to the call. If at 10:20 AM, no activity report from the room console device to the BRC indicates that the call has been attended to, then the BRC automatically escalates the call by adding an LPN-level staff to the required-staff variable of the call data and pushing the new call data to the room console device. Upon receiving the new call data though Communications Engine 308, Application 306 instructs Graphics Engine 308 to properly display the updated call.

The BRC may also be used in setting the required-staff variable for a call that requires more than one staff level in a prescribed order, for instance, an RN-level staff may be needed for preparation and then a Doctor-level staff needed to complete the call. In some embodiments, the room console device is used as an input/output device where the call data received from the BRC is displayed first, showing that an RN-level required. After an RN registers through the room console device, a call update signal noting that an RN-level staff is registered and is attending to the call is sent from the room console device to the BRC. The BRC then updates the required-staff variable associated with the call to a Doctor-level staff requirement and sends the updated call data to the room console device. In some embodiments, instead of using an RN-level staff registration signal to escalate to a Doctor-level staff requirement, the BRC waits to receive a notification from the room console device that the RN-level staff has unregistered. In some embodiments, the BRC keeps track of the amount of time since the RN-level staff registered, and after a predetermined time has elapsed, the BRC escalates the call to a Doctor-level staff requirement.

In some embodiments, the required-staff variable may be set manually even when using a BRC manager. For example, Graphics Engine 310 may receive touchscreen inputs from a staff that selects a staff level displayed on the touchscreen 204 when setting a call to a specific staff-level. Application 306 may receive these touchscreen inputs from Graphics Engine 310, determine that the required-staff level is being updated, and send the updated required-staff level for the call to the BRC. The BRC then updates the required-staff level associated with the call data and sends the updated call data to the room console device.

In the previous discussion with a central manager like the BRC, call data comprising a nurse call object and the required-staff variable is communicated from the BRC to the room console device as an example. In other embodiments, instead of having the required-staff variable along with the nurse call object in the call data sent to the room console device, the call data only includes the nurse call object and a color variable. The color variable indicates the color that the room console device will display the call in. By transmitting color to the room console device instead of the required-staff variable, the room console device is alleviated of the task of determining which color to display when the required-staff variable indicates more than one staff level. In this case, the BRC manages the required-staff variable and determines which color the room console device should display the call based on the required-staff variable. In the foregoing discussion regarding required-staff, text color of the displayed call is used as an example, but a symbol next to a displayed call may be used to convey required-staff level. Assigning a staff level or setting a service may not only be made to an active call.

FIG. 7C shows a screenshot of a situation where a service is being set to a room:bed that does not currently have an active call. When the service icon 504-1 is pressed, a list of room/bed combinations 710 is provided. Depending on the number of rooms, a scroll down icon 606 may be displayed.

Embodiments of the disclosure provide a room console with audio communication capabilities. The room console may be able to conduct intercom and paging functions. For intercom services, the room console may enable communication with a patient station, another room console, another device in the nurse call system environment, or a session initiation protocol (SIP) phone. In some embodiments, audio communication with the room console is limited to half duplex. The room console may support switching talk direction without user interaction using, for example, features similar to a voice operated exchange (VOX). In addition to hands-free switching, the room console may support push to talk (PTT) functionality by having a PTT button. In some cases, audio sessions are goverened by a system defined audio session time limit, thus allowing designers to limit the maximum time the room console may be used per audio communication.

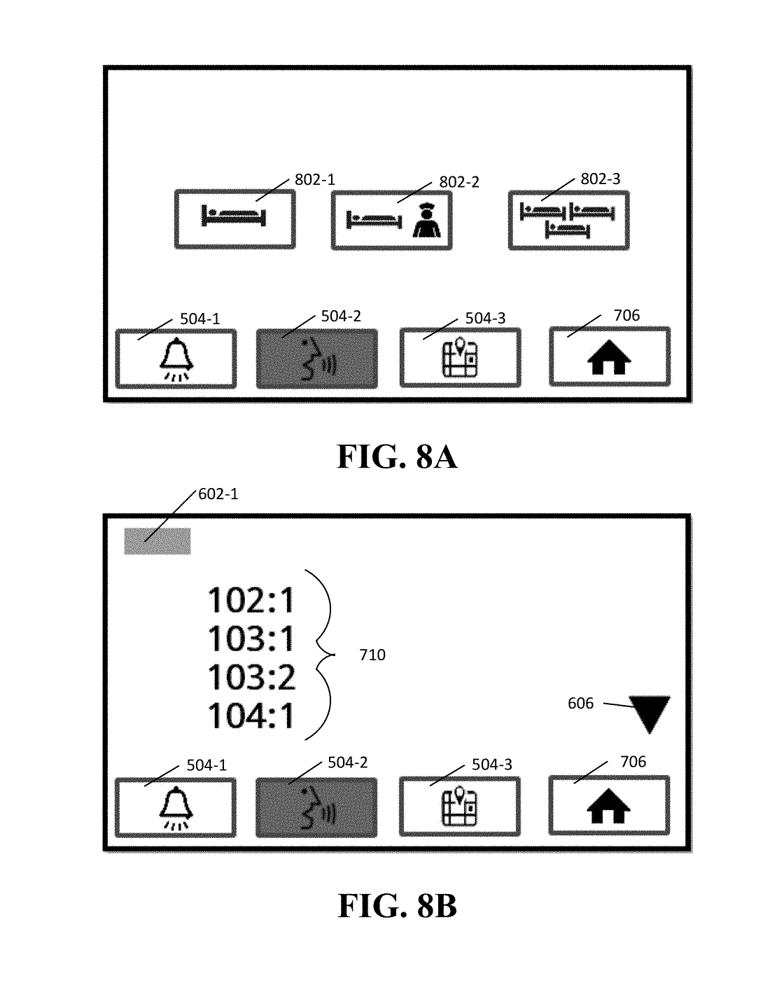

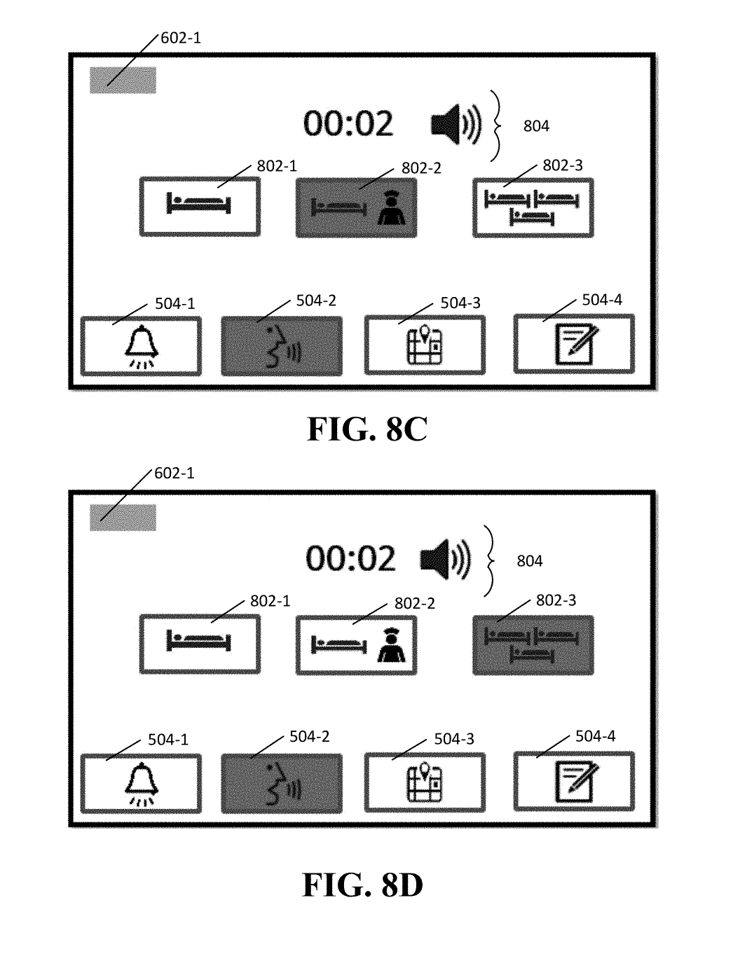

FIGS. 8A-D provide sample screenshots of the room console's touchscreen when the audio function is enabled. In FIG. 8A, when the audio icon 504-2 is pressed, three icons 802 representing three different audio communication modes are provided. From left to right, the audio communication modes are intercom audio 802-1, staff-page 802-2, and zone page 802-3. In the audio communication screen, a home icon 706 is displayed as a function/button instead of the staff registration button which is available from the home screen (see FIGS. 5A-5B). When intercom audio 802-1 is chosen, a screen that shows a list 710 of room:bed entries corresponding to rooms/beds in a predefined zone (e.g., a particular floor or wing of a hospital) is provided to the user as shown in FIG. 8B. Thus, a user can select any bed from the predefined zone to initiate an audio session. The zone may be defined as the network reach of the room console. For example, the room console may be configured in a pediatric wing of a hospital to only initiate audio communication to devices within the pediatric wing, and the room console would be unable to reach devices in, for example, the psychiatric wing. In some embodiments, when intercom audio mode is activated, an audio icon and length of communication are displayed on the touchscreen for the selected room/bed.

FIGS. 8C-D provide screenshots when the staff-page 802-2 and the zone page 802-3 icons, respectively, are selected and an audio communication is in progress. For both of these functions, an audio icon and length of audio communication are displayed in a status area 804. In staff-page mode, the room console pages other room consoles that have a staff registered. In zone page mode, the room console pages all room consoles in a defined zone.

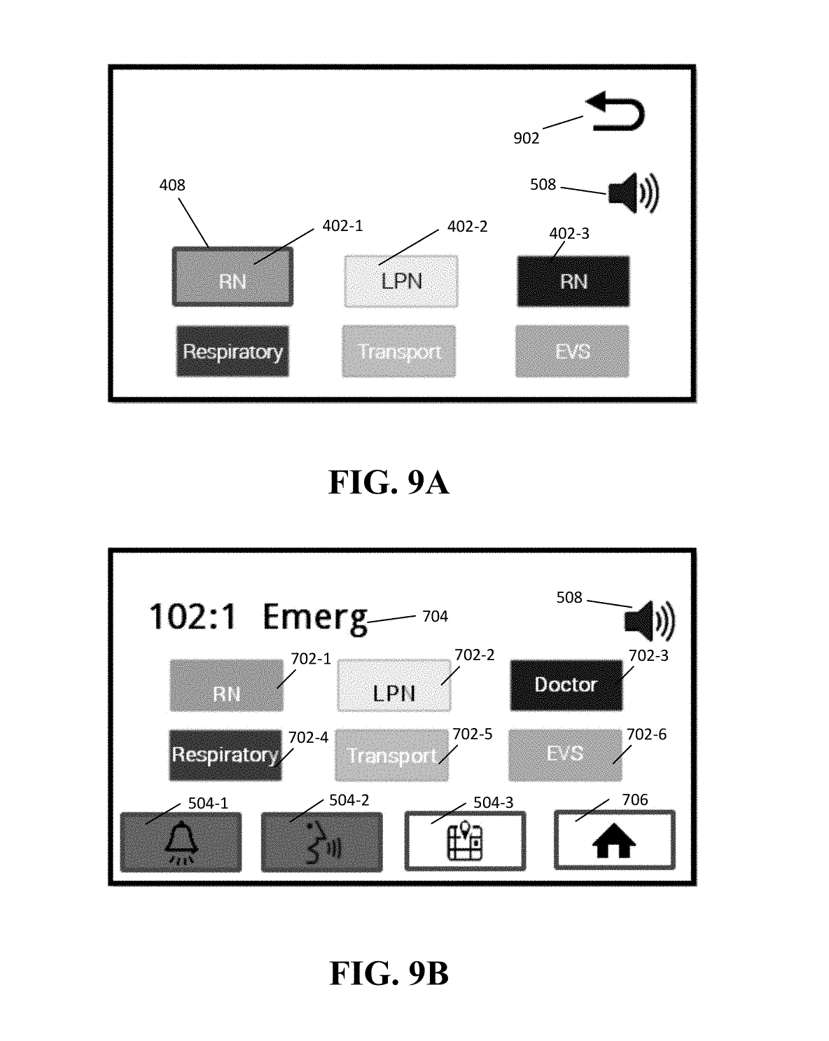

In some embodiments, multitasking is enabled in audio communication. During audio communication, a newly entering staff member can register in the room while the communication is in progress. Also during audio communication, a service can be set to the call in progress. As provided in FIG. 5B and FIGS. 8C-8D, during audio communication, the fourth function button shows staff registration icon 504-4 instead of home icon 706. Thus, while audio communication is in progress, when the staff registration icon 504-4 is pressed, the screen shown in FIG. 9A is provided. In this variant of the staff registration screen, a “Back” icon 902 replaces the “Home” icon. Also shown is the registered level of the staff currently involved in the audio communication. In some embodiments, while an audio communication is in progress, a staff member cannot de-register the last registration. Only new registrations may be performed when only one staff level is registered. A thick border 408 is provided around RN 402-1 showing that an RN level staff is currently registered in the room. A new registration would need to be of another staff member level, for example, LPN, Doctor, Respiratory, Transport, and EVS.

In addition to being able to register a staff member entering the room while an audio call is in progress, the room console supports a staff member setting a service while in audio communication. By pressing the service icon 504-1 in FIG. 5B, the screen in FIG. 9B may be provided. In this screen, the selected call is displayed as item 704, a speaker symbol 508 is displayed to indicate audio mode is active, and the home icon 706 is provided as one of the function icons. Also note that in this screen, the audio icon 504-1 and service icon 504-2 are highlighted to visually indicate that an audio communication is in progress while at the service screen.

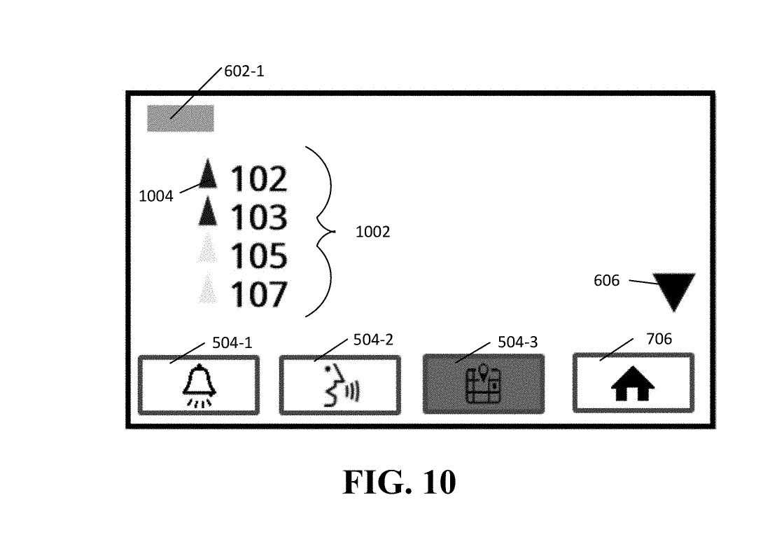

The room console may also provide a locate staff functionality as provided in the screenshot of FIG. 10. In this mode, the locate icon 504-3 is active, allowing a staff member to see a list of rooms 1002. The rooms that have staff in them are signified with a symbol, for example, a triangle symbol 1004 is next to room 102. In some embodiments, the symbol 1004 bears the color of the highest level of staff member registered in that room. In some instances, the selection of a room with a staff member present initiates an intercom session with an audio device in the selected room.

Embodiments of the disclosure provide a room console with registered-staff color coding. The display of a status bar on the room console shows in colors the level of staff registered in a given room. The room console may support staff registration so upon pressing one of the registration buttons, a colored bar appears on the display screen. Each level of staff present in a room may be indicated by a different bar on the display screen. In some embodiments, these colored bars have a fixed location. The purpose of these staff registration bars is to remind staff who are present in the room whether or not they have registered in the room, and also to remind the staff to de-register out of the room when they leave.

Embodiments of the disclosure provide a display of calls that are color-coded to the minimum-level of staff required to respond to the call. The color codes associated with the calls are examples of required-staff level indicators. These indicators allow visual categorization of calls based on a minimum staff level. A color may be assigned to a call when setting a service to the call. The list of calls may be programmed to show the highest priority calls displayed first, and the list may be further organized so that only the rooms with outstanding calls present are displayed. In some instances, a prioritized list with calls of a certain level matching the staff member level are displayed first before other calls.

Embodiments of the disclosure provide a call-out list which is a list of rooms to which a staff member using a room console may initiate an audio communication. This feature allows a staff member to have a short list of rooms to reach out to instead of providing a dial pad where a staff member would have to remember numbers to devices associated with certain rooms. Staff members do not need to arbitrarily call any room, so providing a call-out list feature reduces number memorization by the staff member. In some instances, the configuration of the room console allows a call-out zone to be defined. In a call-out zone, only specific rooms may be listed. In addition to specific rooms, sets of rooms may be defined by areas, groups, or other zones. In some instances, each room on the call-out list can be color-coded to indicate the level of staff present in that room. In other cases, each room on the call-out list can be color-coded to indicate the level of call present in that room.

Embodiments of the disclosure provide a room console device that supports multitasking. While a registered staff member is using the room console device to actively communicate with one or more audio electronic devices, another staff member may register with the same room console device. Additionally, while an audio communication is active, a registered staff member may use the room console device to set a service to an active call. In some instances, while multitasking, an audio icon is displayed on the room console device's touchscreen while setting a service. While multitasking, function icons may change as well to allow a registered staff member to return to a screen that provides details regarding the audio communication. For example, a “Home” icon may be provided while setting a service, and a “Back” icon may be provided while registering another staff member.

Embodiments of the disclosure further provide context-sensitive screens using staff registration. The menu of items displayed and the pending calls displayed on a room console can depend on which level of staff is registered on the room console. This feature de-clutters the screen so that the menu items and list of pending calls displayed on the screen are context-sensitive to the level of staff registered in the room such that together they reflect information deemed most-useful to the level of staff present in the room. In some embodiments, when multiple staff levels are registered on a given room console, menu items and list of pending calls pertaining to the highest-level staff are displayed.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A room console device for management of patient care, the room console device comprising:
a touchscreen, configured to display information and to provide a user interface;
a non-transitory computer-readable medium having processor-executable instructions stored thereon; and
a processor configured to execute the processor-executable instructions to:
perform a staff registration process based on user input provided via the touchscreen;
display an indication of staff in a first room via the touchscreen, wherein the indication of staff is displayed based on a staff level indicator comprising colors corresponding to staff level, symbols corresponding to staff level, and/or patterns corresponding to staff level;
display information regarding outstanding calls via the touchscreen;
display an indication of staff in other rooms via the touchscreen; and
facilitate an audio communication session.

2. The room console device of claim 1, wherein performing a staff registration comprises:
receiving a staff registration signal, the staff registration signal containing staff level information;
displaying a staff level indicator on the touchscreen, the staff level indicator corresponding to the staff level information in the staff registration signal.

3. The room console device of claim 1, wherein the processor is further configured to set a service by:
receiving a call signal on the touchscreen, the call signal indicating a selected outstanding call;
receiving a required-staff level signal on the touchscreen, the required-staff level signal indicating the minimum staff level necessary to address the selected outstanding call; and
displaying information regarding the selected outstanding call along with a required-staff level indicator related to the selected outstanding call,
wherein the required-staff level indicator comprises: (a) a staff level symbol displayed next to the information regarding the selected outstanding call, and/or (b) the information regarding the selected outstanding call being displayed in a color associated with a staff level.

4. The room console device of claim 1, wherein the displayed information regarding outstanding calls comprises a list of calls including call location and call description.

5. The room console device of claim 4, wherein the call location comprises a room number and/or a patient bed number.

6. The room console device of claim 4, wherein a call in the list of calls includes a required-staff level indicator corresponding to the call.

7. The room console device of claim 6, wherein the required-staff level indicator corresponding to the call comprises: (a) a staff level symbol displayed next to information regarding the call, and/or (b) the information regarding the call being displayed in a color associated with a corresponding staff level.

8. The room console device of claim 6, wherein the required-staff level indicator signifies a highest-level staff required to respond to the call or a lowest-level staff required to respond to the call.

9. The room console device of claim 6, wherein the required-staff level indicator is determined from a required-staff variable, the required-staff variable storing a numeric code indicative of a combination of different staff levels or storing an array indicative of a combination of different staff levels.

10. The room console device of claim 9, wherein the processor is further configured to add a staff level to the required-staff variable by:
receiving a required-staff level signal, the required-staff level signal indicating a new staff level necessary to address an outstanding call; and
adding the new staff level to the required-staff variable.

11. The room console device of claim 10, wherein the adding the new staff level to the required-staff variable comprises:
when the required-staff variable stores a first numeric code indicating a first group of staff levels, replacing the first numeric code with a second numeric code, the second numeric code indicating both the first group of staff levels and the new staff level; and
when the required-staff variable stores an array indicating a first group of staff levels, adding the new staff level to the array.

12. The room console device of claim 10, wherein the adding the new staff level to the required-staff variable comprises:
when the required-staff variable stores a first numeric code indicating a first group of staff levels,
creating a second group of staff levels by combining the staff levels in the first group of staff levels and the new staff level,
creating a third group of staff levels by discarding the lowest staff level the second group of staff levels, and
replacing the first numeric code with a second numeric code, the second numeric code indicating the third group of staff levels; and
when the required-staff variable stores an array indicating a first group of staff levels, adding the new staff level to the array, and removing the lowest of all the staff levels in the array.

13. The room console device of claim 1, wherein the displayed indication of staff in other rooms comprises a staff level indicator corresponding to a room in a list of rooms, the staff level indicator signifying a highest staff level registered in the room.

14. The room console device of claim 1, wherein the displayed indication of staff in other rooms comprises a staff level indicator corresponding to a call in a list of calls, the staff level indicator signifying the highest staff level registered in a room corresponding to the call.

15. The room console device of claim 1, wherein facilitating the audio communication session comprises facilitating an intercom audio communication session involving bidirectional audio communication with a patient station, another room console device, or a session initiation protocol (SIP) phone.

16. The room console device of claim 1, wherein facilitating the audio communication session comprises facilitating a paging audio communication session involving one way audio communication to one or more room console devices.

17. The room console device of claim 16, wherein the paging audio communication session is based on a determination of which other rooms have registered staff.

18. A method for management of patient care, the method performed on a room console device by executing instructions stored on a non-transitory computer-readable medium, the method comprising:
displaying, by the room console device, a registration graphical user interface (GUI) on a touchscreen of the room console device, wherein the registration GUI comprises one or more staff level icons;
receiving, by the room console device, a staff registration signal from the touchscreen corresponding to a staff level icon; and
in response to the staff registration signal, displaying, by the room console device, a staff level indicator corresponding to the received staff registration signal on the touchscreen, wherein the staff level indicator comprises a color corresponding to a staff level, a symbol corresponding to the staff level, and/or a pattern corresponding to the staff level.

19. A method for management of patient care, the method performed on a room console device by executing instructions stored on a non-transitory computer-readable medium, the method comprising:
displaying, by the room console device, a graphical user interface (GUI) on a touchscreen of the room console device, wherein the GUI comprises staff level indicators representing at least one registered staff member, wherein a staff level indicator comprises a color corresponding to a staff level, a symbol corresponding to the staff level, and/or a pattern corresponding to the staff level;
receiving, at the touchscreen, a first input signal indicative of a selected audio communication icon;
in response to the received first input signal, displaying on the touchscreen icons corresponding to different audio communication options;
receiving, at the touchscreen, a second input signal indicative of a selected icon corresponding to an audio communication option; and
initiating an audio communication session based on the selected audio communication option.

20. The method of claim 19, wherein the staff level indicators comprise different colors signifying different staff levels.

21. The method of claim 19, wherein the different audio communication options comprise a paging option and an intercom option.

22. The method of claim 21, wherein the paging option comprises paging room console devices located in rooms with at least one registered staff.

23. The method of claim 19, further comprising:
discontinuing the audio communication session when a system timer corresponding to a maximum length has reached a threshold.

24. The method of claim 19, further comprising:
displaying, by the room console device, on the touchscreen a list of rooms; and
receiving a third input signal indicative of a room selected from the list of rooms;
wherein the initiated audio communication session is an intercom audio communication session with an electronic device in the selected room.

25. A system for management of patient care, comprising:
a room console device, configured to:
perform a staff registration process based on user input provided via a touchscreen on the room console device,
display an indication of staff in a first room via the touchscreen, wherein the indication of staff is displayed based on a staff level indicator comprising colors corresponding to staff level, symbols corresponding to staff level, and/or patterns corresponding to staff level,
display an outstanding call, the outstanding call comprising a call text and a required-staff level indicator sent by a controller device,
display an indication of staff in other rooms, and
facilitate an audio communication session; and
the controller device, configured to:
manage a required-staff variable for the outstanding call, the required-staff variable storing staff levels required to address the outstanding call,
determine the required-staff level indicator using the required-staff variable, and send the required-staff level indicator to the room console device.

26. The system of claim 25, wherein the required-staff level indicator comprises: (a) a staff level symbol displayed next to the call text, and/or (b) the call text being displayed in a color associated with a corresponding staff level.

27. The system of claim 25, wherein the required-staff level indicator signifies a highest-level staff required to respond to the outstanding call or a lowest-level staff required to respond to the outstanding call.

28. The system of claim 25, wherein the required-staff variable stores staff levels in a numeric code indicative of a combination of different staff levels or stores staff levels in an array indicative of a combination of different staff levels.

29. The system of claim 28, wherein the controller device is configured to add a new staff level to the required-staff variable by performing the steps of:
when the required-staff variable stores a first numeric code indicating a first group of staff levels, replacing the first numeric code with a second numeric code, the second numeric code indicating both the first group of staff levels and the new staff level; and
when the required-staff variable stores an array indicating a first group of staff levels, adding the new staff level to the array.

30. The system of claim 28, wherein the controller device is configured to add a new staff level to the required-staff variable by performing the steps of:
when the required-staff variable stores a first numeric code indicating a first group of staff levels,
creating a second group of staff levels by combining the staff levels in the first group of staff levels and the new staff level,
creating a third group of staff levels by discarding the lowest staff level the second group of staff levels, and
replacing the first numeric code with a second numeric code, the second numeric code indicating the third group of staff levels; and
when the required-staff variable stores an array indicating a first group of staff levels,
adding the new staff level to the array, and
removing from the array the lowest staff level of all staff levels in the array.

31. The system of claim 25, wherein the controller device is configured to add a new staff level to the required-staff variable when the outstanding call has been active for a predetermined time.
